(19) United States
(12) Patent Application Publication
(10) Pub. No.: US 2002/0039245 A1
(43) Pub. Date: Apr. 4, 2002

(54) Modular card-type disk drive

(75) Inventors: Soon-kyo Hong, Seoul (KR); Byeong-cheon Koh, Sungnam-city (KR); Chul-woo Lee, Sungnam-city (KR); Byoung-young Bae, Pyoungtag-city (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-city (KR)

(21) Appl. No.: 09/962,248

(22) Filed: Sep. 26, 2001

(30) Foreign Application Priority Data
Oct. 4, 2000 (KR) 2000-58322

(51) Int. Cl. G11B 5/02

(52) U.S. Cl. 360/55

(57) ABSTRACT

A disk drive includes a first case including a disk, a disk driving unit, a recording/reproducing device, and a recording/reproducing device driving unit, and a second case including a driving circuit to drive and control the recording/reproducing device and the recording/reproducing device driving unit, where the second case is pivotally connected with the first case, and a flexible cable electrically connects the disk driving unit and the recording/reproducing device driving unit with the driving circuit. Accordingly, the thickness of the first case can be increased since only the second case needs to be inserted into a PCMCIA slot, and a PCMCIA card type disk drive with a large storage capacity can be manufactured.

### CROSS-REFERENCE TO RELATED APPLICATIONS

This application claims the benefit of Korean Application No. 2000-58322, filed Oct. 4, 2001, in the Korean Industrial Property Office, the disclosure of which is incorporated herein by reference.

### BACKGROUND OF THE INVENTION

1. Field of the Invention

The present invention relates to a PCMCIA card type disk drive, and more particularly to a PCMCIA card type disk drive having a large storage capacity created by an improved disk drive structure and being capable of having an expanded storage capacity created by changing storage devices.

2. Description of the Related Art

Peripheral devices used with game machines, camcorders, digital cameras, and laptop computers have to be small. For example, the peripheral devices for laptop computers have been manufactured to be the size of a credit card. However, there is a compatibility problem caused by different standards of each manufacturer. The PCMCIA (Personal Computer Card International Association) is an international standard regulating association that regulates standard for various cards used in personal computers, and especially those used with laptop computers. Examples of these cards include PCMCIA type I, PCMCIA type II, and PCMCIA type III cards, all of which are made according to the standard promulgated by the PCMCIA. The allowable peripheral devices using the PCMCIA standard are memory cards, card type hard disk drives, fax modem cards, and LAN cards.

To connect the peripheral devices to a laptop computer so as to expand its capabilities, the laptop computer needs to have a PCMCIA slot. The PCMCIA slot is shaped to receive a credit card sized PCMCIA card. Within the PCMCIA slot and the PCMCIA card are respective connectors allowing the slot and card to be connected with each other.

As shown in FIG. 1, a conventional PCMCIA card type hard disk drive 1 is shaped to be inserted entirely into a PCMCIA slot 3 in a laptop computer 2. As shown in FIG. 2, the hard disk drive 1 basically includes a frame 10 and a cover 20. At one end of the cover 20 is a connector 21 that is inserted into the PCMCIA slot 3 to be electrically connected with the laptop computer 2. At both ends of the connector 21 there are grooves 21a in a predetermined pattern to connect with protrusions (not shown) formed in the PCMCIA slot 3.

As shown in FIGS. 3 and 4, a circuit board 22 is attached to the bottom of the frame 10. The frame 10 includes a cover frame 10a and a base frame 10b. Two vertically-stacked hard disks 11, a hard disk driving part 12 that drives the hard disks 11, a recording/reproducing device 13 that records and reproduces information to/from the hard disks 11, and a recording/reproducing device driving unit 14 that drives the recording/reproducing device 13 are in a space between the cover and base frames 10a and 10b. The recording/reproducing device driving unit 14 includes a coil 14a, a yoke 14b, and magnets 14c. The hard disk driving unit 12 and a pivot 13a of the record and reproducing device 13 are in the base frame 10b. The recording/reproducing device 13 records and reproduces information to/from the hard disk 11 by radially turning about the pivot 13a of the hard disk 11 in accordance with the driving of the recording/reproducing device driving unit 14.

The square type base frame 10b is connected to the cover 20 using screws 17 which pass through screw holes 16 and 26 formed at four corners of the base frame 10b and the cover 20. The hard disk driving unit 12, the recording/reproducing device driving unit 14, and the circuit board 22 reciprocally transmit a signal via a connector 30, and the connector 30 is connected with a hard disk driving circuit 18 and a recording/reproducing device driving circuit 19.

In the hard disk drive 1, since the hard disk 11, the hard disk driving unit 12, the recording/reproducing device 13, the recording/reproducing device driving unit 14, and the circuit board 22, which are stacked vertically, have to be inserted into the PCMCIA slot 3, the thickness of the hard drive 1 cannot be increased when the hard drive 1 is manufactured. In other words, the conventional hard disk drive 1 cannot increase the number of the hard disks 11 due to the international standard regulation of the PCMCIA card, which causes a problem in creating a disk drive having a large storage capacity.

### SUMMARY OF THE INVENTION

It is an object of the present invention to provide a PCMCIA card type disk drive having an improved structure to create a large storage capacity.

Additional objects and advantages of the invention will be set forth in part in the description which follows and, in part, will be obvious from the description, or may be learned by practice of the invention.

The above and other objects is accomplished by a disk drive according to an embodiment of the present invention, the disk drive having a first case including a first disk, a disk driving unit, a recording/reproducing device, and a recording/reproducing device driving unit, a second case including a connector formed at one end of the second case and a driving circuit to drive and control the disk driving unit and the recording/reproducing device driving unit and the second case is connected with the first case turn a second disk of the second case, and a connection member to electrically connect the disk driving unit and the recording/reproducing device driving unit with the driving circuit.

According to another embodiment of the present invention, a PCMCIA card type disk drive changes storage devices to expand storage capacity as necessary.

According to a further embodiment of the present invention, a disk drive having a first case including a disk, a disk driving unit, a recording/reproducing device, and a recording/reproducing device driving unit, a second case including a connector formed at one end of the second case and a driving circuit to drive and control the disk driving unit and the recording/reproducing device driving unit, and a connection member to removably connect the first case and the second case and electrically connect the disk driving unit, the recording/reproducing device driving unit, and the driving circuit.

### BRIEF DESCRIPTION OF THE DRAWINGS

The above-mentioned and other objects and advantages of the invention will become apparent and more readily appreciated by describing the preferred embodiments of the present in detail referring to the appended drawings, in which

FIG. 1 is a schematic perspective view showing a conventional PCMCIA card type hard disk drive being inserted into a PCMCIA slot of a laptop computer;

FIG. 2 is a perspective view showing a conventional PCMCIA card type hard disk drive;

FIG. 3 is a plan view showing the hard disk drive of FIG. 2 without a cover frame and an upper yoke;

FIG. 4 is a sectional view of the hard disk drive of FIG. 2;

FIG. 5 is a perspective view showing a PCMCIA card type disk drive according to an embodiment of the present invention;

FIG. 6 is an exploded perspective view of the disk drive of FIG. 5;

FIG. 7 is a schematic perspective view showing the disk drive of FIG. 5 being inserted into a PCMCIA slot of a laptop computer;

FIG. 8 is a perspective view showing the disk drive of FIG. 5 being completely folded;

FIG. 9 is an exploded perspective view of a PCMCIA card type disk drive according to another embodiment of the present invention;

FIG. 10 is a perspective view showing a circuit board of the disk drive of FIG. 9 having multiple connectors; and

FIG. 11 is a perspective view showing the first case being connected with the second case in the disk drive of FIG. 9 by a separate connection cable according to a further embodiment of the present invention.

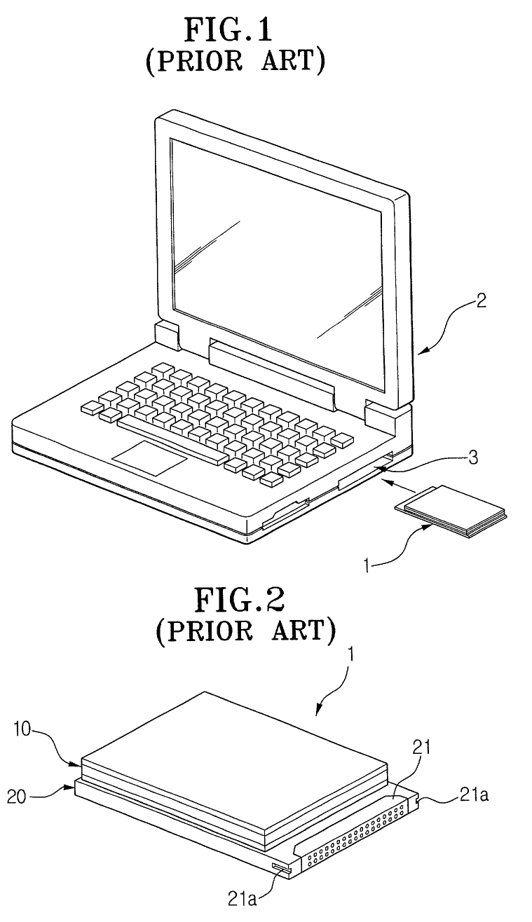

### DETAILED DESCRIPTION OF THE PREFERRED EMBODIMENTS

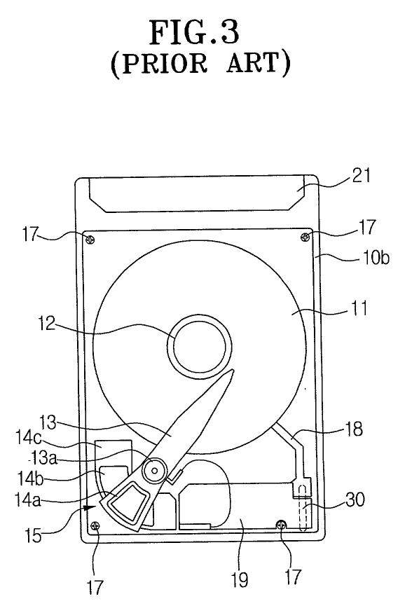

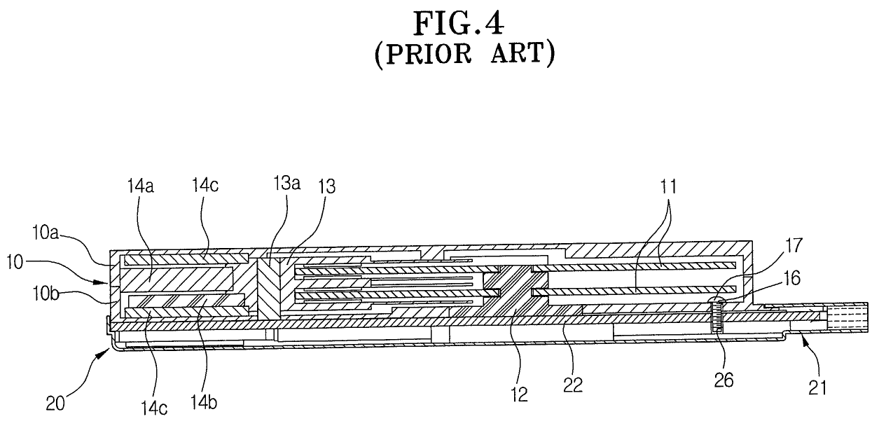

A detailed description according to the preferred embodiments of the present invention will now be made referring to the attached drawings. Throughout the description, the same reference numeral will be used for the same parts with the conventional hard disk drive shown in FIGS. 3 and 4, and the description of the same parts will therefore be omitted.

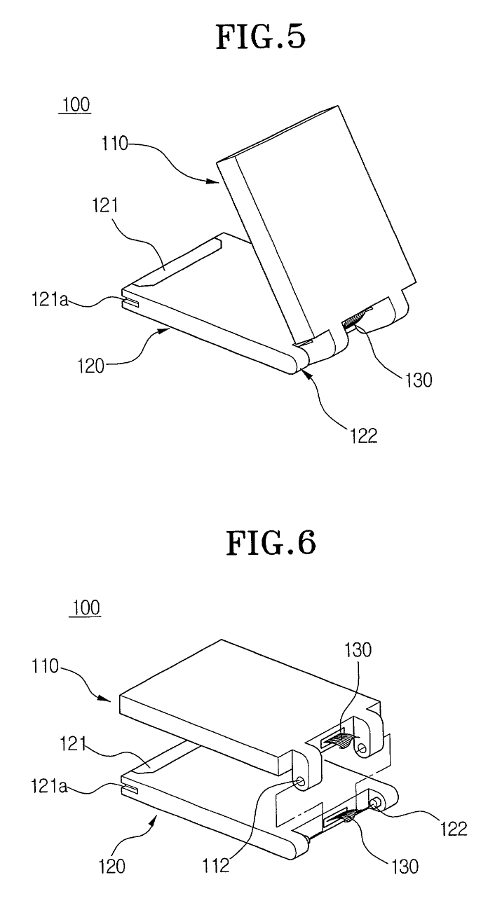

As shown in FIGS. 5 and 6, a disk drive 100 according to an embodiment of the present invention includes a first case 110 and a second case 120, which are pivotally connected to each other. The first case 110 includes similar elements to those shown in FIGS. 3 and 4 including one or more disks 11, a disk driving unit 12, a recording/reproducing device 13, and a recording/reproducing device driving unit 14 formed therein. The second case 120 also includes similar elements to those shown in FIGS. 3 and 4 including a circuit board 22 having a driving circuit 18 to drive and control the disk driving unit 12 and the recording/reproducing device driving unit 14 of the first case 110. The detailed description about the construction of the first case 110 and the second case 120 will be omitted since the construction is the same with the hard disk drive described in the part of the related art shown in FIGS. 3 and 4.

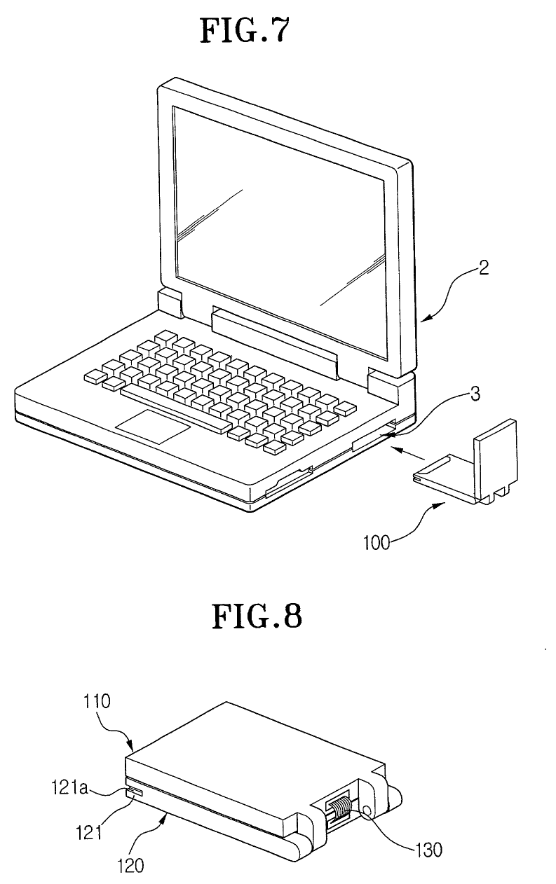

At one end of the second case 120, a connector 121 is formed to be electrically connected with a PCMCIA slot 3 of a laptop computer 2 shown in FIG. 7. Grooves 121a of a predetermined pattern are formed in one end and opposite sides of the second case 120 across the connector 121 in order to connect with protrusions (not shown) formed in the PCMCIA slot 3. The disk driving unit 12 and the recording/reproducing device driving unit 14 of the first case 110 and the driving circuit 18 of the second case 120 are electrically connected by a connection member 130. In addition, it is understood that the driving circuit 18 could be disposed in the first case 110 such that the second case 120 is used to form a communication pathway, electrical or otherwise, to allow the data to be transmitted between the laptop computer 2 and the recording and reproducing device 13.

A pair of hinge holes 112 are formed in the first case 110, and a pair of hinge pins 122 are formed in the second case 120. The hinge pins 122 are inserted into the hinge holes 112 to pivotally connect the first case 110 and the second case 120. A connector 130 is installed between the hinge holes 112 and the hinge pins 122. The connector 130 is a flexible cable that electrically connects the driving unit 12 of the first case 110 and the driving circuit 18 of the second case 120. The flexible cable 130 is thin film wherein a minute circuit is formed inside. The flexible cable 130 is flexible such that it can be bent and unbent without any limitation in accordance with the turning of the first case 110 relative to the second case 120.

While not shown, it is understood that the hinge pins 122 can be formed on the first case 110 and the hinge holes 112 can be formed in the second case 120. Further, while the connection member 130 is shown pivotally connecting the first case 110 and the second case 120, other types of connectors, such as flexible plastic connectors, could be used so long as the first case 110 and the second case 120 can be pivotally connected.

Since the first case 110 can turn relative to the second case 120, the disk drive 100 can be installed in the laptop computer 2 by inserting the second case 120 into the PCMCIA slot 3 as shown in FIG. 7. Therefore, the thickness of the first case 110, which is not inserted into the PCMCIA slot 3, can be made as thick as it needs to be. In other words, the number of the disks 11 that are installed in the first case 110 can be increased. After inserting the second case 120 into the PCMCIA slot 3 of the laptop computer 2, the disk drive 100 can be used when the first case 110 is at a right or any other angle relative to the second case 120. Further, as shown in FIG. 8, when storing or carrying the disk drive 100, a user can fold the first case 110 and the second case 120 to reduce the volume of the disk drive 100.

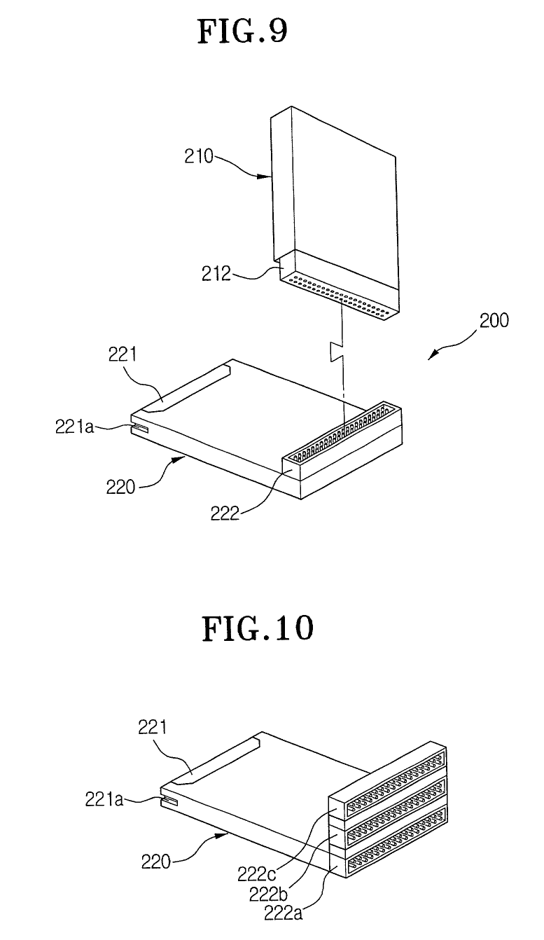

As shown in another embodiment of the present invention in FIGS. 7 and 9, a disk drive 200 includes a first case 210 and a second case 220 being connected with each other. At one end of the second case 220, a connector 221 is electrically connected with the PCMCIA slot 3 of the laptop computer 2, and includes certain patterned grooves (221 a) of a predetermined pattern formed in one end and the opposite sides of the second case 210 across the connector 221 to connect with protrusions (not shown) formed in the PCMCIA slot 3.

A first connector 212 is used to connect the first case 210 with the second case 220 and is formed at on end of the first case 210. A second connector 222, which connects with the first connector 212, is formed at the second case 220. Since the first connector 212 and the second connector 222 are removably engaged with each other, the first case 210 and the second case 220 can be easily connected and separated. The first connector 212 and the second connector 222 also electrically connect the disk driving unit 12 of FIG. 3 and the recording/reproducing device driving unit 14 of FIG. 3 installed in the first case 210 with the driving circuit 18 in the second case 220. For the disk drive 200, since the first case 210 can be separated from the second case 220, a user can change the first case 210 when the first case 210 is broken or there is a need to expand the storage capacity.

On the other hand, as shown in FIG. 10, a plurality of second connectors 222a, 222b, 222c are vertically stacked and attached to the second case 220. Therefore, the first case 210 is inserted into the second connector 222a and, simultaneously, other peripheral devices needed for expansion, such as a modem card, can be inserted into the remaining second connectors 222b, 222c. By doing so, the problem caused by the narrow space needed to form a slot 3 in a laptop computer 2 can be solved.

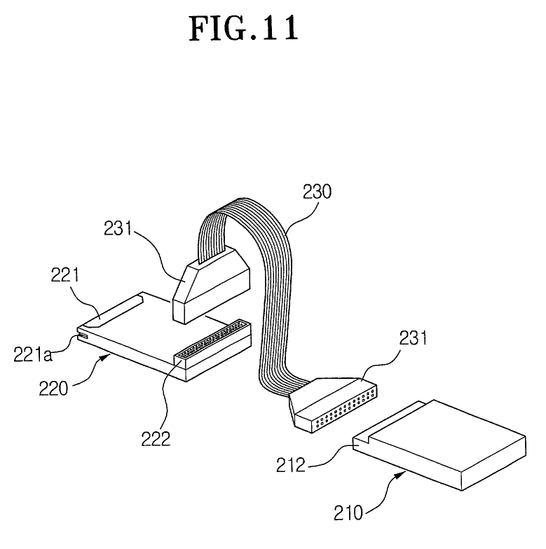

In addition, as shown in the embodiment of the present invention shown in FIG. 11, the first connector 212 and the second connector 222 can be connected by a connection cable 230 having connectors 231 formed at both ends.

As described above, according to the disk drive of the present invention, since the first case and the second case are pivotally and/or removably connected with each other, only the second case 120 needs to be inserted into the PCMCIA slot when the disk drive is installed in the laptop computer. Thus, the thickness of the first case can be increased to obtain a disk drive with a large storage capacity.

Furthermore, according to the present invention, the cost can be reduced by allowing a user to change only the first case when there is a need for expanding the storage capacity of the drive by removably connecting the first drive with the second drive.

In addition, according to the present invention, a plurality of second connectors are formed in the second case embedded with a circuit board to receive a plurality of PCMCIA cards including other expandable peripheral devices like modem cards without having to form a plurality of PCMCIA slots in the laptop computer.

Although the preferred embodiments of the present invention have been described, it will be understood by those skilled in the art that the present invention should not be limited to the described preferred embodiments, but various changes and modifications can be made within the spirit and scope of the present invention. Accordingly, the scope of the present invention is not limited within the described range but the following claims and their equivalents.

What is claimed is:

1. A disk drive comprising:
a first case including a disk, a disk driving unit to drive the disk, a recording and reproducing device to record and reproduce data to and from the disk, and a recording/reproducing device driving unit to drive the recording and reproducing device;
a second case including a driving circuit to drive and control the recording/reproducing device driving unit and the disk driving unit, where said second case is pivotally connected with said first case; and
a connection member to electrically connect the recording/reproducing device and the recording/reproducing device driving unit with the driving circuit.

2. The disk drive of claim 1, wherein said first case and said second case are hinged to each other.

3. A disk drive comprising:
a first case including a disk, a disk driving unit to drive the disk, a recording/reproducing device, and a recording/reproducing device driving unit to drive the recording/reproducing device;
a second case including a connector formed at one end and a driving circuit to drive and control the disk driving unit and the recording/reproducing device driving unit; and
a connection member to electrically connect the recording/reproducing device and the recording/reproducing device driving unit with the driving circuit of said second case, and to removably connect said first case and said second case.

4. The disk drive of claim 3, wherein said connection member includes a first connector formed at one end of said first case, and a second connector formed at the other end of said second case and being removably connected with the first connector.

5. The disk drive of claim 4, wherein said second case further comprises additional second connectors formed at the other end to receive additional devices.

6. The disk drive of claim 4, further comprising a connection cable having connectors at both ends to connect the first connector and the second connector.

7. A device for use with an external device, comprising:
a first case including a peripheral device;
a second case that is connected with said first case; and
a controller disposed within one of said first case and said second case to drive the peripheral device,
wherein
one of said first and second cases is a PCMCIA compliant card, and
said first and second cases provide a communication pathway to transmit data between the external device and the peripheral device.

8. The device according to claim 7, wherein said first case is attached to and able to move relative to said second case.

9. The device according to claim 8, wherein said first case is pivotally attached to said second case.

10. The device according to claim 9, wherein one of said first case and said second case comprises hinge holes, and the other of said first case and said second case comprises hinge pins corresponding to the hinge holes so as to pivotally attach said first and second cases

11. The device according to claim 8, further comprises a connector cable to connect said first case to said second case.

12. The device according to claim 7, wherein said controller is disposed in said second case, and said second case is the PCMCIA compliant card.

13. The device according to claim 11, wherein said controller is disposed in said second case, and said second case is the PCMCIA compliant card.

14. The device according to claim 13, wherein said first case is not PCMCIA compliant and cannot be inserted into a PCMCIA compliant slot of the external device.

15. The device according to claim 7, further comprising a connector to removably connect said first case and said second case and to provide the communication pathway.

16. The device according to claim 15, wherein said controller is disposed in said second case, and said second case is the PCMCIA compliant card.

17. The device according to claim 16, wherein said first case is not PCMCIA compliant and cannot be inserted into a PCMCIA compliant slot of the external device.

18. The device according to claim 15, wherein said connector comprises a flexible connector having ends, wherein one of the ends is connected to said first case and another one of the ends is connected to said second case.

19. The device according to claim 15, wherein said connector comprises ends, wherein one of the ends is connected to said first case and another one of the ends is connected to said second case.

20. The device according to claim 19, wherein said connector comprises additional ends to be connected to additional peripheral devices and to form additional communication pathways between the external device and the additional peripheral devices.

21. The device according to claim 20, wherein one of the additional peripheral devices includes a modem card.

22. The device according to claim 7, wherein
the peripheral device comprises a disk, a disk driving unit to drive the disk, a recording and/or reproducing device to record and/or reproduce data to and/or from the disk, and a recording and/or reproducing device driving unit to drive the recording and reproducing device, and
said controller drives the recording/reproducing device driving unit and the disk driving unit.

23. The device according to claim 22, wherein said first case comprises additional disks driven by the disk driving unit and having data recorded and/or reproduced using the recording and/or reproducing device.

24. The device according to claim 14, wherein
the peripheral device comprises a disk, a disk driving unit to drive the disk, a recording and/or reproducing device to record and/or reproduce data to and/or from the disk, and a recording and/or reproducing device driving unit to drive the recording and reproducing device, and
said controller drives the recording/reproducing device driving unit and the disk driving unit.

25. The device according to claim 17, wherein
the peripheral device comprises a disk, a disk driving unit to drive the disk, a recording and/or reproducing device to record and/or reproduce data to and/or from the disk, and a recording and/or reproducing device driving unit to drive the recording and reproducing device, and
said controller drives the recording/reproducing device driving unit and the disk driving unit.

26. The device according to claim 12, wherein said first case comprises a first connector and said second case further comprises a second connector that removably receives the first connector to form the communication pathway.

27. The device according to claim 26, wherein
said second case is received by a slot of the external device in an insertion direction, and
the second connector is disposed on said second case such that said first case is at an angle to the insertion direction.

28. The device according to claim 27, wherein said first case is roughly perpendicular to the insertion direction.

29. The device according to claim 26, wherein said second case further comprises additional connectors that are stacked with the second connector.

30. The device according to claim 26, wherein
said second case is received by a slot of the external device in an insertion direction, and
the second connector is disposed on said second case such that said first case is parallel to the insertion direction.

31. The device according to claim 29, wherein
said second case is received by a slot of the external device in an insertion direction, and
the second connector is disposed on said second case such that said first case is parallel to the insertion direction.

32. A disk drive for use with an external device, comprising:
a case;
a disk disposed in said case;
a disk driving unit disposed in said case to drive said disk;
a recording and/or reproducing device disposed in said case to record and/or reproduce data to and/or from said disk;
a recording and/or reproducing device driving unit disposed in said case to drive said recording and reproducing device; and
a connector to form a communication pathway with a controller disposed within an external case that drives the recording/reproducing device driving unit and the disk driving unit and to transmit the data read from or recorded to said disk between the external device and said recording and reproducing device.

33. The disk drive of claim 32, wherein the disk drive is not a PCMCIA compliant card.

34. The disk drive of claim 32, wherein the external case is a PCMCIA compliant card.

35. The disk drive of claim 33, wherein the external case is the PCMCIA compliant card.

36. The disk drive of claim 32, wherein said connector is removably attached to the external case while the external case is attached to the external device so as to be removed while the external case remains attached to the external device.

37. The disk drive of claim 35, wherein said connector is removably attached to the external case while the external case is attached to the external device so as to be removed while the external case remains attached to the external device.

38. A device to connect a peripheral device and an external device, comprising:
a case;
a controller within said case;
a first connector to form a communication pathway with the peripheral device disposed in an external case to drive and control the peripheral device; and
a second connector to form a communication pathway to allow the data to be transmitted between the peripheral device and the external device.

39. The device of claim 38, wherein the external case is not a PCMCIA compliant card.

40. The device of claim 38, wherein said case is a PCMCIA compliant card.

41. The device of claim 39, wherein said case is the PCMCIA compliant card.

42. The device of claim 38, wherein said first connector is removably attached to the external case so that the external case is able to be disconnected from said first connector while the external device remains attached to said second connector.

43. The device of claim 41, wherein said first connector is removably attached to the external case so that the external case is able to be disconnected from said first connector while the external device remains attached to said second connector.

44. The device of claim 38, wherein:
the peripheral device comprises a disk driving unit to drive a disk, and a recording and/or reproducing device driving unit disposed in the external case to drive a recording and reproducing device to record and/or reproduce data to and/or from the disk, and
said controller to control the disk driving unit and the recording and/or reproducing device driving unit.

45. The device of claim 41, wherein:
the peripheral device comprises a disk driving unit to drive a disk, and a recording and/or reproducing device driving unit disposed in the external case to drive a recording and reproducing device to record and/or reproduce data to and/or from the disk, and
said controller to control the disk driving unit and the recording and/or reproducing device driving unit.

46. The device of claim 42, wherein:
the peripheral device comprises a disk driving unit to drive a disk, and a recording and/or reproducing device driving unit disposed in the external case to drive a recording and reproducing device to record and/or reproduce data to and/or from the disk, and
said controller to control the disk driving unit and the recording and/or reproducing device driving unit.
